(19) United States
(12) Patent Application Publication
(10) Pub. No.: US 2020/0316976 A1
(43) Pub. Date: Oct. 8, 2020

(54) THERMOSENSITIVE RECORDING MEDIUM

(71) Applicants: Ichiro SAWAMURA, Shizuoka (JP); Yasuroh YOKOTA, Shizuoka (JP); Kazuyuki UETAKE, Shizuoka (JP); Yohji IDE, Shizuoka (JP); Satoshi ARAI, Shizuoka (JP); Toshiaki ASAI, Shizuoka (JP); Kazumasa NODA, Shizuoka (JP); Yuta OKABE, Kanagawa (JP)

(72) Inventors: Ichiro SAWAMURA, Shizuoka (JP); Yasuroh YOKOTA, Shizuoka (JP); Kazuyuki UETAKE, Shizuoka (JP); Yohji IDE, Shizuoka (JP); Satoshi ARAI, Shizuoka (JP); Toshiaki ASAI, Shizuoka (JP); Kazumasa NODA, Shizuoka (JP); Yuta OKABE, Kanagawa (JP)

(21) Appl. No.: 16/305,291

(22) PCT Filed: May 30, 2017
(86) PCT No.: PCT/JP2017/020046

§ 371 Date: Nov. 28, 2018

(30) Foreign Application Priority Data
May 30, 2016 (JP) 2016107760
May 29, 2017 (JP) 2017-105834

(51) Int. Cl. B41M 5/44; B41M 5/36

(52) U.S. Cl. CPC B41M 5/44; B41M 2205/04; B41M 5/363

(57) ABSTRACT

A thermosensitive recording medium including a base and a recording layer including a photothermal conversion material and disposed on the base, wherein the thermosensitive recording medium is configured to record information in the thermosensitive recording medium through laser light irradiation, and wherein a color difference delta E between a color tone A of a background observed through the thermosensitive recording medium in which information is not recorded and a color tone B of the background directly observed without the thermosensitive recording medium in which information is not recorded is 20 or less, and a film thickness D of an area of the recording layer irradiated with laser light after information recording performed by laser light irradiation is 140% or greater but 250% or less relative to a film thickness C of the recording layer of the thermosensitive recording medium in which information is not recorded.

### TECHNICAL FIELD

The present disclosure relates to a thermosensitive recording medium.

### BACKGROUND ART

Thermosensitive recording media are configured to form a color image on a white or pale color background, but there is a case where a white image is formed on a transparent or color background depending on use. For example, product labels are typically formed by printing, but there is a demand that variable information can be displayed on product labels on demands. The above-described demand is difficult to achieve with a typical printing system. To this end, a thermosensitive recording system is suitably used. However, it is difficult to form a white image on thermosensitive recording media existing in the art, and there is a problem that a design of a product label is restricted.

As a thermosensitive recording medium capable for forming a white image, for example, proposed is a thermosensitive recording medium, in which an aqueous coating material for laser marking is applied onto a base, where the aqueous coating material includes a carboxyl group-containing self-emulsifying aromatic-based epoxy resin and fluorine mica (see, for example, PTL 1).

Moreover, proposed is a reversible thermosensitive recording medium prepared by dispersing an organic low-molecular material, such as higher fatty acid, in a resin base, and capable of reversibly repeating between a transparent state and a white opaque state according to heating temperatures (see, for example, PTLs 2 and 3).

### CITATION LIST

### Patent Literature

### PTL 1: Japanese Unexamined Patent Application Publication No. 2001-055537

### PTL 2: Japanese Unexamined Patent Application Publication No. 54-119377

### PTL 3: Japanese Unexamined Patent Application Publication No. 55-154198

### SUMMARY OF INVENTION

### Technical Problem

The present disclosure has an object to provide a thermosensitive recording medium having excellent transparency of a recording layer in which information is not recorded, and capable of forming a white image having excellent concealment and having excellent physical durability of a recorded area.

### Solution to Problem

A thermosensitive recording medium of the present disclosure as a means for solving the aforementioned problems includes a base and a recording layer including a photothermal conversion material and disposed on the base. The thermosensitive recording medium is configured to record information in the thermosensitive recording medium through laser light irradiation. A color difference delta E between a color tone A of a background observed through the thermosensitive recording medium in which information is not recorded and a color tone B of the background directly observed without the thermosensitive recording medium in which information is not recorded is 20 or less. A film thickness D of an area of the recording layer irradiated with laser light after information recording performed by laser light irradiation is 140% or greater but 250% or less relative to a film thickness C of the recording layer of the thermosensitive recording medium in which information is not recorded.

### Advantageous Effects of Invention

The present disclosure is capable of providing a thermosensitive recording medium having excellent transparency of a recording layer in which information is not recorded, and capable of forming a white image having excellent concealment and having excellent physical durability of a recorded area.

### BRIEF DESCRIPTION OF DRAWINGS

FIG. 1 is a photograph depicting a state where a white image is formed on a thermosensitive recording medium of the present disclosure.

FIG. 2 is one example of an enlarged cross-section photograph with a magnification of 750 times, depicting cross-sections of the thermosensitive recording medium of the present disclosure in which information is not recorded and the thermosensitive recording medium of the present disclosure after information recording.

FIG. 3A is an enlarged photograph with a magnification of 650 times, depicting a surface of the thermosensitive recording medium of Example 1 after information recording.

FIG. 3B is an enlarged photograph with a magnification of 650 times, depicting a surface of the thermosensitive recording medium of Comparative Example 1 after information recording.

FIG. 4 is a photograph depicting one example of the thermosensitive recording medium of Example 1 colored in white at laser power of 100%.

FIG. 5 is a photograph depicting another example of the thermosensitive recording medium of Comparative Example 1 colored in white at laser power of 100%.

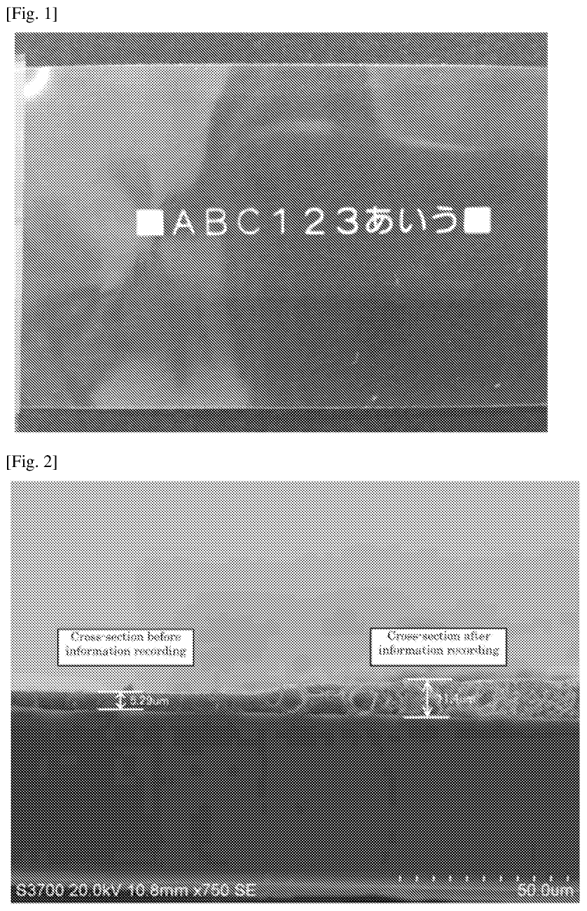

### DESCRIPTION OF EMBODIMENTS

(Thermosensitive Recording Medium)

A thermosensitive recording medium of the present disclosure includes a base and a recording layer including a photothermal conversion material and disposed on the base. The thermosensitive recording medium is configured to record information in the thermosensitive recording medium through laser light irradiation. A color difference delta E between a color tone A of a background observed through the thermosensitive recording medium in which information is not recorded and a color tone B of the background directly observed without the thermosensitive recording medium in which information is not recorded is 20 or less. A film thickness D of an area of the recording layer irradiated with laser light after information recording performed by laser light irradiation is 140% or greater but 250% or less relative to a film thickness C of the recording layer of the thermosensitive recording medium in which information is not recorded. The thermosensitive recording medium preferably further includes an organic resin layer and a film, and may further include other layers, if necessary.

The thermosensitive recording medium of the present disclosure is configured to change a state of a recording layer from a transparent state to a white opaque state upon heating to thereby form a white image on a transparent or color base.

A mechanism of white coloring (a change from transparent to white) in the thermosensitive recording medium of the present disclosure is not clear, but the mechanism is assumed as follows. The thermosensitive recording medium in a transparent state includes a structure including fine particles and a thermoplastic resin, in which a material configured to absorb semiconductor laser light and convert the absorbed light into heat is homogeneously dispersed in the structure. As a result of thermal conversion, foaming occurs to thereby form voids in the structure. The temperature of the thermosensitive recording medium is decreased without losing the voids and then the voids are fixed. Light is scattered by the voids and the scattered light is viewed as white.

Since in the thermosensitive recording medium of a white-colored state, a film thickness D of an area of the recording layer irradiated with laser light after information recording performed by laser light irradiation is 140% or greater but 250% or less relative to a film thickness C of the area of the recording layer of the thermosensitive recording medium in which information is not recorded, a white image which has excellent concealment and excellent physical durability of a recorded area can be formed.

In the present disclosure, the white image means an area where a light transmittance is lowered compared to a non-heated area owing to light-scattering caused by the above-described change by the heating.

FIG. 1 is a photograph depicting a state where a white image is formed on a thermosensitive recording medium of the present disclosure. As illustrated in FIG. 1, a vivid white image is obtained by recording on the transparent recording layer of the thermosensitive recording medium of the present disclosure by a laser marker.

(Color Difference Delta E)

The color difference delta E between a color tone A of a background observed through the thermosensitive recording medium in which information is not recorded and a color tone B of the background observed directly without the thermosensitive recording medium in which information is not recorded is 20 or less. The color tone A of the background observed through the thermosensitive recording medium of the present disclosure in which information is not recorded is a color tone of a color background observed by placing the thermosensitive recording medium of the present disclosure on a surface of the color background, and observing the color background through the thermosensitive recording medium of the present disclosure in which information is not recorded. The color tone B of the background observed without the thermosensitive recording medium of the present disclosure in which information is not recorded is a color tone obtained by directly observing the color background.

The color background may be a background present independently from the thermosensitive recording medium of the present disclosure or may be integrated with the thermosensitive recording medium of the present disclosure. The background present independently from the thermosensitive recording medium is a color background present, as a separate member, in contact with or adjacent to the thermosensitive recording medium of the present disclosure, and the color background may be present on a surface of the base of the thermosensitive recording medium of the present disclosure opposite to the surface of the base on which the recording layer is present, or on a surface of the recording layer of the thermosensitive recording medium of the present disclosure opposite to the surface of the recording layer on which the base is present.

Moreover, examples of the background integrated with the thermosensitive recording medium of the present disclosure include: a color base of the thermosensitive recording medium itself, where the color base is formed of a color base; a color layer disposed directly or via another layer on at least one of surfaces of the base of the thermosensitive recording medium of the present disclosure, where the base is formed of a transparent base; and a color layer disposed directly or via another layer on a surface of the recording layer of the thermosensitive recording medium opposite to a surface of the recording layer on which the base is disposed, where the base is formed of a transparent base.

In the present specification, the transparent base means a base having a haze value of 15 or less and the color base means a base other than the transparent base. The haze value can be measured according to ISO 14782.

In any of the above-mentioned cases, the color background can be observed from a surface of the recording layer opposite to the surface of the recording layer on which the color background is disposed.

Next, a measuring method of the color tone A of the background observed through the thermosensitive recording medium of the present disclosure in which information is not recorded, a measuring method of the color tone B of the background observed without the thermosensitive recording medium of the present disclosure in which information is not recorded, and a calculation method of a color difference are described.

In a case where the thermosensitive recording medium includes a transparent base and does not have a background, an area of the thermosensitive recording medium in which information is not recorded is placed on a white part of “Color Control Patch” of “Color Separation Guides and Gray Scales/Q14” available from Eastman Kodak Company, and the color of the area of the thermosensitive recording medium is measured by a colorimeter (x-rite exact standard, available from X-Rite Inc.) under conditions of D65 and a 2°-viewing field to determine a L*a*b* value (L*₁a*₁b*₁) of the color tone of the background observed through the thermosensitive recording medium in which information is not recorded. Next, the white of “Color Control Patch” of “Color Separation Guides and Gray Scales/Q14” available from Eastman Kodak Company is measured under the conditions mentioned above to determine a L*a*b* value (L*₀a*₀b*₀) of the color tone of the background observed without the thermosensitive recording medium in which information is not recorded. Next, a color difference delta E is determined according to Formula 1 below.

In a case where the background is integrated with the thermosensitive recording medium including a color base, moreover, the thermosensitive recording medium is placed on a white part of “Color Control Patch” of “Color Separation Guides and Gray Scales/Q14” available from Eastman Kodak Company in a manner that the recording layer is above relative to the color background of the area of the thermosensitive recording medium in which information is not recorded. The color of the area is measured by means of a colorimeter (x-rite exact standard, available from X-Rite Inc.) under conditions of D65 and a 2°-viewing field to determine a L*a*b* value (L*₁a*₁b*₁) of the color tone A of the background observed through the thermosensitive recording medium in which information is not recorded. Next, only the color base is placed on the white part of “Color Control Patch” of “Color Separation Guides and Gray Scales/Q14” available from Eastman Kodak Company in a manner that the surface of the base at the side of the recording layer comes at the top, and the color is measured under the conditions mentioned above to determine the a L*a*b* value (L*₀a*₀b*₀) of the color tone B of the background observed without the thermosensitive recording medium in which information is not recorded. Next, a color difference delta E is determined according to Formula 1 below.

In a case where a background is a color layer disposed directly or via another layer on a surface of the base of the thermosensitive recording medium of the present disclosure opposite to the surface of the base on which the recording layer is disposed, where the base is a transparent base, or a color layer disposed directly or via another layer on a surface of the recording layer of the thermosensitive recording medium of the present disclosure opposite to the surface of the recording layer on which the base is disposed, where the base is a transparent base, a thermosensitive recording medium from which the color layer serving as a background is removed is produced, and a color difference delta E is determined according to the same method as in the case where the thermosensitive recording medium includes a transparent base and does not have a background.

Delta E=((L*₁−L*₀)²+(a*₁−a*₀)²+(b*₁−b*₀)²))^{0.5} (Formula 1)

(Film Thickness D of Area of Recording Layer Irradiated with Laser Light after information Recording Performed by Laser Light Irradiation)

A film thickness D of an area of the recording layer irradiated with laser light after information recording performed by laser light irradiation relative to a film thickness C of the recording layer of the thermosensitive recording medium in which information is not recorded is 140% or greater but 250% or less, preferably 150% or greater but 250% or less. When the film thickness of the area after information recording is 140% or greater, concealment can be improved. When the film thickness of the area after information recording is 250% or less, formation of defective images can be inhibited as well as forming a white image having excellent physical durability of a recorded area.

The film thickness of the area of the recording layer irradiated with laser light after information recording can be determined by Formula 2 below.

[Film thickness D (%) of an area of a recording layer irradiated with laser light after information recording performed by information recording)]=[film thickness of the recording layer after information recording]/[film thickness C of the recording layer in which information is not recorded]×100 (Formula 2)

Note that, the film thickness can be measured, for example, by observing a cross-section of the recording layer along a thickness direction using a scanning electron microscope (device name: S-3700, available from Hitachi High-Technologies Corporation), etc.

For the layer irradiation, for example, an LD laser marker (device name: Ricoh rewritable marker LDM200, available from Ricoh Company Limited), etc., can be used.

The laser irradiation is not particularly limited and laser power may be appropriately selected depending on the intended purpose. A film thickness of an area of the recording layer irradiated with laser light after information recording can be controlled by selecting laser power.

<Base>

A shape, structure, size, color tone material, etc., of the base are not particularly limited and may be appropriately selected depending on the intended purpose. Examples of the shape include plate shapes, and sheet shapes. The structure may be a single-layer structure or a laminate structure. The size may be appropriately selected depending on a size of the thermosensitive recording medium, etc.

The material of the base is not particularly limited and may be appropriately selected depending on the intended purpose. Examples of the material include inorganic materials and organic materials.

Examples of the inorganic materials include glass, quartz, silicon, silicon oxide, aluminium oxide, SiO₂, and metals.

Examples of the organic materials include: paper, such as high quality paper, art paper, coated paper, and synthetic paper; cellulose derivatives such as cellulose triacetate; and plastic films, such as polyester resins (e.g., polyethylene terephthalate (PET) and polybutylene terephthalate), polycarbonate, polystyrene, polymethyl methacrylate, polyethylene, and polypropylene. These may be used alone or in combination.

For the purpose of improving adhesion, the base is preferably subjected to a surface treatment, for example, by a corona discharge treatment, an oxidization reaction treatment (e.g., chromic acid), an etching treatment, a treatment for achieving easy adhesion, an antistatic treatment, etc.

An average thickness of the base is not particularly limited and may be appropriately selected depending on the intended purpose. The average thickness is preferably 2 micrometers or greater but 5,000 micrometers or less, and more preferably 20 micrometers or greater but 2,000 micrometers or less.

<Recording Layer>

The recording layer is disposed on the base.

(Pore Diameter of Bubbles Along Thickness Direction of Recording Layer Generated in Area of Recording Layer Irradiated with Laser Light after Information Recording)

A pore diameter of bubbles along a thickness direction of the recording layer, where the bubbles are generated in the area of the recording layer irradiated with laser light after information recording, is 10% or greater but 30% or less relative to the film thickness of the area of the recording layer irradiated with laser light after information recording. When the pore diameter is 10% or greater but 30% or less, transparency of the recording layer in which information is not recorded is excellent, concealment is excellent, and a white image having excellent physical durability of a recorded area can be formed.

The pore diameter is calculated by observing a cross-section of the information-recorded area of the thermosensitive recording medium along a thickness direction by means of a scanning electron microscope (for example, device name: S-3700, available from Hitachi High-Technologies Corporation) to take an electron microscopic photograph with a magnification of 6,000 times, measuring sizes of voids along a thickness direction of the recording layer within the photograph, and determining a number average value of the measured values.

The recording layer includes a photothermal conversion material, and may further include other components, if necessary.

The photothermal conversion material means a material that absorbs laser light and converts the absorbed laser light into heat. The photothermal conversion material is roughly classified into an inorganic-based material and an organic-based material.

Examples of the inorganic-based material include particles of any one of carbon black, metal boride, and metal oxides of Ge, Bi, In, Te, Se, and Cr. The inorganic-based material is preferably a material having large absorption of light of a near-infrared wavelength range and having less absorption of light of a visible wavelength range, and is more preferably the metal boride and the metal oxide.

As the metal boride and the metal oxide, for example, at least one selected from the group consisting of hexaboride, tungsten oxide compounds, antimony tin oxide (ATO), indium tin oxide (ITO), and zinc antimonite.

Examples of the hexaboride include LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆, and (La, Ce)B₆.

Examples of the tungsten oxide compounds include fine particles of tungsten oxide represented by a general formula: WyOz (with the proviso that W is tungsten, O is oxygen, and z/y being 2.2 or greater but 2.999 or less), or particles of composite tungsten oxide represented by a general formula: MxWyOz (with the proviso that M is at least one element selected from the group consisting of H, He, alkali metal, alkaline earth metal, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I, W is tungsten, O is oxygen, x/y being 0.001 or greater but 1 or less, z/y being 2.2 or greater but 3.0 or less), as disclosed in WO 2005/037932 and Japanese Unexamined Patent Application Publication No. 2005-187323.

Among them, cesium-containing tungsten oxide is particularly preferable in view of large absorption at a near infrared region, and small adsorption at a visible region.

Among the antimony tin oxide (ATO), the indium tin oxide (ITO), and the zinc antimonate, ITO is particularly preferable in view of large absorption at a near infrared region, and small adsorption at a visible region.

As the organic-based material, various dyes are appropriately used depending on wavelengths of light to be absorbed. In the case where a semiconductor laser is used as a light source, a near infrared-absorbing dye having an absorption peak at around 600 nm or longer but 1,200 nm or shorter is used. Specific examples of the organic-based material include cyanine dyes, quinone-based dyes, quinolone derivatives of indonaphthol, phenylenediamine-based nickel complexes, and phthalocyanine-based dyes.

The above-listed photothermal conversion materials may be used alone or in combination.
The photothermal conversion material may be included in a thermosensitive recording layer, or included in a layer other than the thermosensitive recording layer. In the case where the photothermal conversion material is included in a layer other than the thermosensitive recording layer, the layer including the photothermal conversion material is preferably disposed to be in contact with the thermosensitive recording layer.
An amount of the photothermal conversion material is preferably 0.1% by mass or greater but 10% by mass or less, more preferably 0.3% by mass or greater but 5% by mass or less, relative to a total mass of the fine particles and the thermoplastic resin.

The fine particles mean particles having a volume average particle diameter of 0.07 micrometers or greater but 0.5 micrometers or less. The volume average particle diameter can be measured, for example, by means of a laser diffraction/scattering particle size analyzer (LA-920, available from HORIBA, Ltd.).

The fine particles are not particularly limited and may be appropriately selected depending on the intended purpose. Examples of the fine particles include: inorganic compounds, such as metal hydroxides, metal oxides, hydrates of metal oxides, metal chlorides, basic metal chlorides, metal sulfides, metal salts, hydrates of metal salts, clay minerals, metal powder, carbonic acid salts, and hydrogen carbonates; and organic particles. These may be used alone or in combination.

Among them, metal hydroxides, metal oxides, hydrates of metal oxides, basic metal chlorides, metal salts, hydrates of metal salts, clay minerals, carbonic acid salts, basic carbonic acid salts, and hydrogen carbonates are preferable.

Examples of the metal hydroxides include hydroxide of metals other than alkali metals, such as aluminium hydroxide, magnesium hydroxide, and calcium hydroxide.

Examples of the metal oxides include aluminium oxide, silica, titanium oxide, zinc oxide, and antimony oxide.

Examples of the hydrates of metal oxides include hydrate of alumina.

Examples of the basic metal chlorides include basic aluminium chloride and basic magnesium chloride.

Examples of the metal salts include barium sulfate, lead sulfate, and calcium sulfate.

Examples of the hydrates of metal salts include calcium sulfate dihydrate, magnesium sulfate heptahydrate, and sodium molybdate dehydrate.

Examples of the clay minerals include talc, kaolin, smectite, montmorillonite, and muscovite.
Examples of the carbonic acid salts include zinc carbonate, calcium carbonate, magnesium carbonate, barium carbonate, and lead carbonate.
Examples of the hydrogen carbonates include sodium bicarbonate and potassium bicarbonate.
The inorganic compounds above may be used alone or in combination. Among them, aluminium hydroxide, alumina hydrate, basic aluminium chloride, calcium carbonate, sodium bicarbonate, and magnesium carbonate are preferable in view of concealment of a white image.
Examples of the organic particles include particles of polystyrene, polymethyl methacrylate, polyethylene, polypropylene, acryl-styrene-based resins, melamine-based resins, benzoguanamine-based resins, polyamide-based resins, polyacrylonitrile-based resins, and silicone resins.

An amount of the fine particles is preferably 20% by mass or greater but 90% by mass or less relative to a total amount of the recording layer.

—Thermoplastic Resin—

The thermoplastic resin is not particularly limited and may be appropriately selected depending on the intended purpose. Examples of the thermoplastic resin include organic binders and inorganic binders.

The above-listed thermoplastic resins may be used alone or in combination. Note that, the organic binder and the inorganic binder may be used in combination.

The organic binders are not particularly limited and may be appropriately selected depending on the intended purpose. Examples of the organic binders include thermoplastic resins, heat-curable resins, and photocurable resins. Properties of these resin are not limited, and the resins may be such as water-soluble resins, water-dispersible resins, and solvent-soluble resins.

Examples of the organic binders include acrylic resins, polyvinyl alcohol resins, starch or derivatives of starch, derivatives of cellulose (e.g., hydroxymethyl cellulose, hydroxyethyl cellulose, carboxymethyl cellulose, methyl cellulose, and ethyl cellulose), water-soluble polymers (e.g., sodium polyacrylate, polyvinyl pyrrolidone, acrylamide-acrylic acid ester copolymers, styrene-acryl copolymers, acryl amide-acrylic acid ester-methacrylic acid terpolymers, alkali salts of styrene-maleic anhydride copolymers, alkali salts of isobutylene-maleic anhydride copolymers, polyacrylamide, sodium alginate, gelatin, and casein), emulsions (e.g., polyvinyl acetate, polyurethane, polyacrylic acid, polyacrylate, vinyl chloride-vinyl acetate copolymers, polybutyl methacrylate, and ethylene-vinyl acetate copolymers), and latex (e.g., styrene-butadiene copolymers and styrene-butadiene-acryl copolymers). These may be used alone or in combination.

Among them, acrylic resins and styrene-acryl copolymers are preferable in view of transparency of a background (non-coloring area) of the thermosensitive recording medium and concealment of an image.

As the thermoplastic resin, an appropriately synthesized resin may be used, or a commercial product may be used. The commercial product is not particularly limited and may be appropriately selected depending on the intended purpose. Examples of the commercial product include product name: Joncryl PDX7323 (styrene-acryl copolymer, available from BASF SE, glass transition temperature: 30 degrees Celsius, solid content: 42% by mass), product name: Joncryl PDX7177 (styrene-acryl copolymer, available from BASF SE, glass transition temperature: 113 degrees Celsius, solid content: 42% by mass), product name: Joncryl PDX7667 (styrene-acryl copolymer, available from BASF SE, glass transition temperature: 75 degrees Celsius, solid content: 45% by mass), and product name: Joncryl PDX7341 (styrene-acryl copolymer, available from BASF SE, glass transition temperature: 15 degrees Celsius, solid content: 49% by mass).

FIG. 4 is a photograph depicting one example of the thermosensitive recording medium produced in Example 1, where recording is performed at laser power of 100% to color in white.

FIG. 5 is a photograph depicting one example of the thermosensitive recording medium produced in Comparative Example 1, where recording is performed at laser power of 100% to color in white.

The fine particles and the thermoplastic resin preferably form a state where the fine particles are homogeneously dispersed in a matrix of the thermoplastic resin. When the fine particles and the thermoplastic resin form a structure where the fine particles present close together, transparency of the recording layer may become low, or a density of a white image may be insufficient.

Moreover, the photothermal conversion material is preferably homogeneously dispersed in the matrix of the thermoplastic resin. When the photothermal conversion material is homogeneously dispersed, the higher recording sensitivity can be obtained.

Whether the photothermal conversion material is homogeneously dispersed in the matrix of the thermoplastic resin or not can be confirmed, for example, by observing a cross-section of the recording medium by means of a scanning electron microscope (device name: S-3700, available from Hitachi High-Technologies Corporation), etc., or observing an element distribution by energy dispersive X-ray spectrometry.

A deposition amount of the thermosensitive recording layer after drying is not particularly limited and may be appropriately selected depending on the intended purpose. The deposition amount is preferably 1 g/m² or greater but 20 g/m² or less, more preferably 3 g/m² or greater but 10 g/m² or less.

A mass ratio (A:B) between the fine particles A and the thermoplastic resin B is preferably from 1:5 through 1:0.1, more preferably from 1:2 through 1:0.3, and particularly preferably from 1:1 through 1:0.5.

—Other Components—

The above-mentioned other components are not particularly limited and may be appropriately selected depending on the intended purpose. Examples of the above-mentioned other components include heat-fusible materials, surfactants, lubricants, and fillers.

<Organic Resin Layer>

The organic resin layer is not particularly limited and may be appropriately selected depending on the intended purpose. The organic resin layers are preferably disposed between the base and the recording layer, and disposed on a surface of the recording layer.

The organic resin layer is not particularly limited and may be appropriately selected depending on the intended purpose. The organic resin layer may be a single layer or a multiple layer.

The multiple layer is not particularly limited and may be appropriately selected depending on the intended purpose. For example, the multiple layer preferably a layer including 2 layers or more but 10 layers or less, and more preferably a layer including 2 layers or more but 5 layer or less.

A haze value of the organic resin layer is not particularly limited and may be appropriately selected depending on the intended purpose. The haze value is preferably 1 or greater but 10 or less. When the haze value is 1 or greater but 10 or less, transparency of the thermosensitive recording medium can be improved. The have value can be measured according to ISO 14782.

A resin of the organic resin layer is not particularly limited and may be appropriately selected depending on the intended purpose. Examples of the resin include polyacrylonitrile resins, urethane resins, and acrylic polyol resins. These may be used alone or in combination.

As the resin of the organic resin layer, an appropriately synthesized resin may be used, or a commercial product may be used.

<Film>

The film is disposed on the organic resin layer disposed on a surface of the recording layer. Specifically, the film is disposed on the organic resin layer that is disposed on a surface of the recording layer opposite to a surface of the recording layer on which the base is disposed.

As the film, a film identical to the base can be used.

<Color Layer>

A color layer is optionally disposed in the thermosensitive recording medium of the present disclosure. A position in the thermosensitive recording medium at which the color layer is disposed is not particularly limited. Specific examples of the position at which the color layer is disposed include: on a surface of the base opposite to a surface of the base on which the recording layer is disposed; between the organic resin layer disposed on a surface of the base, and the recording layer; between the recording layer and the organic resin layer disposed on a surface of the recording layer opposite to a surface of the recording layer on which the base is disposed; on the organic resin layer disposed on a surface of the recording layer opposite to a surface of the recording layer on which the base is disposed; and on a surface of the film opposite to a surface of the film on which the recording layer is disposed.

The position at which the color layer is disposed is more preferably on a surface of the base opposite to a surface of the base on which the recording layer is disposed, on a surface of the organic resin layer disposed on a surface the recording layer opposite to a surface of the recording layer on which the base is disposed, and on a surface of the film opposite to a surface of the film on which the recording layer is disposed.

A type of the color layer is not particularly limited, and examples of the type of the color layer include: various general printing inks, such as aqueous inks, organic solvent-based inks, and ultraviolet ray-curable inks; and various coating liquids including dyes and/or pigments.

A method for disposing the color layer is not particularly limited. Examples of the method include: various printing methods known in the art, such as inkjet printing, offset printing, gravure printing, flexographic printing, and screen printing; and various coating methods, such as blade coating, gravure coating, gravure offset coating, bar coating, roll coating, knife coating, air knife coating, comma coating, U comma coating, AKKU coating, smoothing coating, microgravure coating, reverse roll coating, 4- or 5-roll coating, dip coating, curtain coating, slide coating, and die coating.

<Other Layers>

The above-mentioned other layers are not particularly limited and may be appropriately selected depending on the intended purpose. Examples of the above-mentioned other layers include protective layers, under layers, ultraviolet ray-absorbing layers, oxygen-barrier layers, intermediate layers, backing layers, organic resin layers, and pressure-sensitive organic resin layers.

The thermosensitive recording medium can be processed into a desired shape depending on the intended use. Examples of the shape include card shapes, tag shapes, label shapes, sheet shapes, roll shapes, etc.

(Thermosensitive Recording Composition)

The thermosensitive recording composition includes a photothermal conversion material, and preferably includes fine particles and a thermoplastic resin having glass transition temperature of 20 degrees Celsius or higher but 80 degrees Celsius or lower. The thermosensitive recording composition may further include other components, if necessary.
As the photothermal conversion material, a photothermal conversion material identical to the photothermal conversion material in the recording layer of the thermosensitive recording medium can be used.
As the fine particles, fine particles identical to the fine particles in the recording layer of the thermosensitive recording medium can be used.
As the thermoplastic resin having glass transition temperature of 20 degrees Celsius or higher but 80 degrees Celsius or lower, a thermoplastic resin identical to the thermoplastic resin having glass transition temperature of 20 degrees Celsius or higher but 80 degrees Celsius or lower in the recording layer of the thermosensitive recording medium can be used.
Examples of the above-mentioned other components include solvents. In case of a UV-curable coating material, for example, monomers, oligomers, and reactive diluents play a function of a solvent. Moreover, examples of additives for adjusting coating ability, or adjusting properties of a coating film formed by coating, which are included in the above-mentioned other components, include surfactants, antifoaming agents, lubricants, curing agents, and antistatic agents.

(Coating Material)

The coating material includes the thermosensitive recording composition, and may further include other components, if necessary.

Examples of the above-mentioned other components include solvents. In case of a UV-curable coating material, for example, monomers, oligomers, and reactive diluents play a function of a solvent. Moreover, examples of additives for adjusting coating ability, or adjusting properties of a coating film formed by coating, which are included in the above-mentioned other components, include surfactants, antifoaming agents, lubricants, curing agents, and antistatic agents.

(Ink)

The ink includes the thermosensitive recording composition, and may further include other components, if necessary.

Examples of the above-mentioned other components include solvents. In case of a UV-curable coating material, for example, monomers, oligomers, and reactive diluents play a function of a solvent. Moreover, examples of additives for adjusting coating ability, or adjusting properties of a coating film formed by coating, which are included in the above-mentioned other components, include surfactants, antifoaming agents, lubricants, curing agents, and antistatic agents.

(Production Method of Thermosensitive Recording Medium)

The production method of the thermosensitive recording medium of the present disclosure includes a step where the coating material is applied onto a base by coating to form a thermosensitive recording layer, or a step where the ink is applied onto a base to form a thermosensitive recording layer. The production method may further include other steps, if necessary.

The coating method is not particularly limited, and various coating systems known in the art can be applied. Examples of the coating method include blade coating, gravure coating, gravure offset coating, bar coating, roll coating, knife coating, air knife coating, comma coating, U comma coating, AKKU coating, smoothing coating, microgravure coating, reverse roll coating, 4- or 5-roll coating, dip coating, curtain coating, slide coating, and die coating.

The application method is not particularly limited, and various printing systems known in the art can be applied. Examples of the application method include inkjet systems, offset printing, gravure printing, flexographic printing, and screen printing.

Examples of the above-mentioned other steps include an organic resin layer-forming step and a film-bonding step.

(Thermosensitive Recording Method)

The thermosensitive recording method includes a step where recording is performed on the thermosensitive recording medium of the present disclosure by laser light irradiation. The thermosensitive recording method may further include other steps, if necessary.

The heating is preferably performed by laser light irradiation in view of recording speed and resolution of an image.

In the case where recording is performed by the laser light irradiation, a laser for use is appropriately selected depending on the intended purpose. Examples of the laser include semiconductor lasers, solid-state lasers, dye lasers, and gas lasers, such as of CO₂.

### EXAMPLES

The present disclosure will be described in more detail by way of the following Examples. However, the present disclosure should not be construed as being limited to these Examples.

### Example 1

<Production of Aluminium Hydroxide Dispersion Liquid (A Liquid)>

Aluminium hydroxide powder (HIGILITE H-43M, available from SHOWA DENKO K.K.): 60 parts by mass

25% by mass aqueous solution of a special polycabroxylic acid-based polymer surfactant (DEMOL EP, available from Kao Corporation): 3 parts by mass
Water: 137 parts by mass
The composition above was dispersed by means of a sand grinder until a median diameter measured by a laser diffraction/scattering particle size analyzer (LA-920, available from HORIBA, Ltd.) was to be 0.2 micrometers, to thereby obtain (A Liquid).

<Production of Photothermal Conversion Material Dispersion Liquid (B Liquid)>

Cesium tungsten oxide powder (FUJI EL MWO3, available from Fuji Pigment Co., Ltd.): 10 parts by mass

25% by mass aqueous solution of a special polycabroxylic acid-based polymer surfactant (DEMOL EP, available from Kao Corporation): 0.5 parts by mass

Water: 94.5 parts by mass

The composition above was pulverized and dispersed by means of a sand grinder until a median diameter measured by a laser diffraction/scattering particle size analyzer (LA-920, available from HORIBA, Ltd.) was to be 0.2 micrometers, to thereby obtain (B Liquid).

<Production of Thermosensitive Coating Material (C Liquid)>

The following composition was stirred and mixed to thereby obtain a thermosensitive coating material (C Liquid).

The (A Liquid): 48.8 parts by mass

Styrene-acrylic resin emulsion (a styrene-acryl copolymer, Joncryl PDX7323, available from BASF SE, glass transition temperature: 30 degrees Celsius, solid content: 42% by mass): 34.8 parts by mass

The (B Liquid): 7.7 parts by mass

Water: 8.7 parts by mass

<Production of Thermosensitive Recording Medium>

The (C Liquid) was applied onto a polyethylene terephthalate (PET) film having a thickness of 50 micrometers and a haze value of 3.7 by a wire bar, the applied (C Liquid) was dried to dispose a thermosensitive recording layer having a deposition amount of 8.7 g/m², to thereby obtain a transparent thermosensitive recording medium.

<Recording on Thermosensitive Recording Medium>

Recording was performed on the transparent thermosensitive recording medium using an LD laser marker (Ricoh rewritable laser marker LDM200, available from Ricoh Company Limited) under the following conditions, to thereby obtain a white solid image.

—Recording Conditions—

Working distance: 150 mm

Scanning speed: 1,500 mm/s
Wavelength of laser light: 980 nm
Laser power: 50%

(Evaluation)

Evaluations of the following items were performed.

<Concealment>

The obtained white image was placed on a black part of “Color Control Patch” of “Color Separation Guides and Gray Scales/Q14” available from Eastman Kodak Company, and image density of the white image was measured by means of a reflection densitometer (RD-914, available from Macbeth). The lower value of image density means that black in the background can be covered up and concealment is high. The result is presented in Table 3.

<Measurement of Color Difference Delta E>

An area of the obtained thermosensitive recording medium before information recording was placed on a white part of “Color Control Patch” of “Color Separation Guides and Gray Scales/Q14” available from Eastman Kodak Company, and the color of the area of the thermosensitive recording medium was measured by a colorimeter (x-rite exact standard, available from X-Rite Inc.) under conditions of D65 and a 2°-viewing field to determine a L*a*b* value (L*₁a*₁b*₁) of the color tone of the background observed through the thermosensitive recording medium before information recording. Next, the white of “Color Control Patch” of “Color Separation Guides and Gray Scales/Q14” available from Eastman Kodak Company is measured under the conditions mentioned above to determine a L*a*b* value (L*₀a*₀b*₀) of the color tone of the background observed without the thermosensitive recording medium.

Next, a color difference delta E was determined according to Formula 3 below.

Delta E=((L*₁−L*₀)²+(a*₁−a*₀)²+(b*₁−b*₀)²))^{0.5} (Formula 3)

The result is presented in the column of “Delta E of observed background color tone” in Table 3 below.

<Foam Structure>

Cross-section photographs of the obtained thermosensitive recording medium to which information had not been recorded and the obtained thermosensitive recording medium after information recording along a thickness direction were taken with a magnification of 6,000 times by means of a scanning electron microscope (S-3700, available from Hitachi High-Technologies Corporation), to measure a film thickness of the recording layer before and after information recording, and a size of a void. The film thicknesses before and after information recording were each determined by measuring a thickness of only the recording layer portion from the cross-section photograph. Moreover, the pore diameter was determined by measuring sizes of voids along the thickness direction of the recording layer within the cross-section photograph, and calculating a number average value of the measured values. The results are presented in Table 3 below.

The film thickness of the area irradiated with laser light after information recording relative to the film thickness of the area of the recording layer in which information is not recorded was determined by Formula 4 below. The result is presented in Table 3 below.

[Film thickness D (%) of the area of the recording layer irradiated with laser light after information recording performed by laser light irradiation]=[film thickness of the recording layer after information recording]/[film thickness C of the recording layer in which information is not recorded]×100 (Formula 4)

<Inspection of Defective Image>

The presence of any floating of the obtained solid image (solid area) from the base was visually confirmed. The result is presented in Table 3 below.

<Evaluation of Physical Durability of Image>

The solid printed area to which the image had been formed was abraded with a black cloth by running the black cloth forwards and backwards 5 times by means of a clock meter (product name: CM-1, available from ATLAS ELECTRIC DEVICES CO.). Then, states of the solid printed area and the black cloth were observed, and evaluated with numeral values of 5 steps from 1 through 5 steps below. Note that, the larger numeral value indicates that the thermosensitive recording medium has more excellent physical durability of the image.

(Evaluation Criteria)

5: The image was not peeled at all, and a peeled-off coated layer was not deposited on the black cloth, hence it was an excellent level.

4: There was no decrease in image density, and the ink was very slightly deposited on the black cloth, hence it was a level having no problem on practical use.

3: The density of the recorded image was decreased, but a surface of the base or the organic resin layer was not exposed, hence it was a level where durability was slightly insufficient.

2: The recorded image was partially peeled off, and part of the surface of the base or the organic resin layer was exposed, hence it was a level where durability was insufficient.

1: The recorded image was completely peeled off, the surface of the base or the organic resin layer was exposed, and hence it was level where the thermosensitive recording medium was not be able to bear practical use.

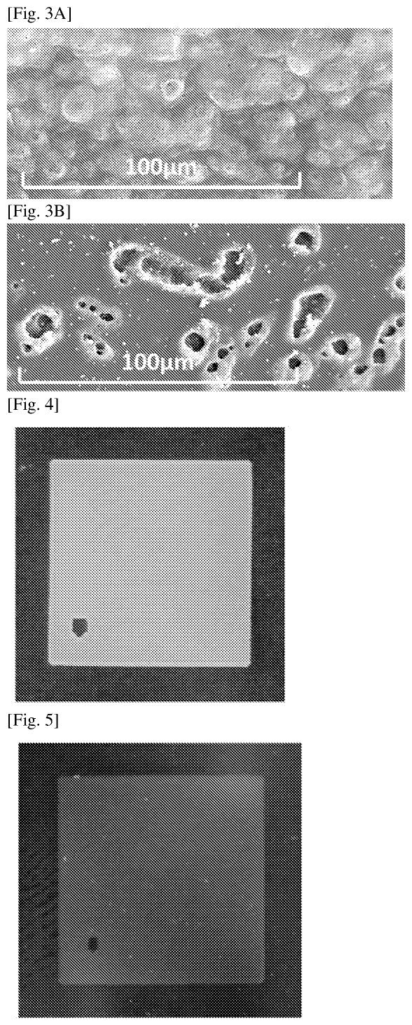

Moreover, an enlarged photograph of a surface of the thermosensitive recording medium of Example 1 with a magnification of 650 times after information recording is presented in FIG. 3A.

### Example 2

A thermosensitive recording medium produced under the same conditions as in Example 1 was subjected to recording under the same conditions as in Example 1, except that the laser power in <Recording on thermosensitive recording medium> of Example 1 was changed to 65%, and evaluations were performed under the same conditions as in Example 1. The results are presented in Table 3 below.

### Example 3

A thermosensitive recording medium produced under the same conditions as in Example 1 was subjected to recording under the same conditions as in Example 1, except that the laser power in <Recording on thermosensitive recording medium> of Example 1 was changed to 80%, and evaluations were performed under the same conditions as in Example 1. The results are presented in Table 3 below.

### Example 4

<Production of Calcium Carbonate Dispersion Liquid (D Liquid)>

Calcium carbonate powder (Brilliant 15, available from SHIRAISHI KOGYO KAISHA, LTD.): 60 parts by mass

25% by mass aqueous solution of a special polycabroxylic acid-based polymer surfactant (DEMOL EP, available from Kao Corporation): 3 parts by mass

Water: 137 parts by mass

The composition above was dispersed by means of a sand grinder until a median diameter measured by a laser diffraction/scattering particle size analyzer (LA-920, available from HORIBA, Ltd.) was to be 0.11 micrometers, to thereby obtain (D Liquid).

<Production of Thermosensitive Coating Material (E Liquid)>

The following composition was stirred and mixed to thereby obtain a thermosensitive coating material (E Liquid).

The (D Liquid): 48.8 parts by mass

Styrene-acrylic resin emulsion (styrene-acryl copolymer, Joncryl PDX7323, available from BASF SE, glass transition temperature: 35 degrees Celsius, solid content: 42% by mass): 34.8 parts by mass

The (B Liquid): 7.7 parts by mass

Water: 8.7 parts by mass

<Production of Thermosensitive Recording Medium>

The (E Liquid) was applied onto a polyethylene terephthalate (PET) film having a thickness of 50 micrometers by a wire bar, the applied (E Liquid) was dried to dispose a thermosensitive recording layer having a deposition amount of 8.8 g/m², to thereby obtain a transparent thermosensitive recording medium.

<Recording on Thermosensitive Recording Medium>

Recording was performed under the same printing conditions as in Example 1, and evaluations were performed under the same conditions as in Example 1. The results are presented in Table 3 below.

### Example 5

A thermosensitive recording medium produced under the same conditions as in Example 4 was subjected to recording under the same conditions as in Example 1, except that the laser power in <Recording on thermosensitive recording medium> of Example 1 was changed to 65%, and evaluations were performed under the same conditions as in Example 1. The results are presented in Table 3 below.

### Example 6

A thermosensitive recording medium produced under the same conditions as in Example 4 was subjected to recording under the same conditions as in Example 1, except that the laser power in <Recording on thermosensitive recording medium> of Example 1 was changed to 80%, and evaluations were performed under the same conditions as in Example 1. The results are presented in Table 3 below.

### Example 7

A thermosensitive recording medium was produced under the same conditions as in Example 1, except that in <Production of thermosensitive coating material (C Liquid)> of Example 1, the added amount of the styrene-acrylic resin emulsion (Joncryl PDX7323, available from BASF SE, glass transition temperature: 30 degrees Celsius, solid content: 42% by mass) was changed to 17.4 parts by mass. The thermosensitive recoding medium was subjected to recording under the same conditions as in Example 1 except that the laser power in <Recording on thermosensitive recording medium> of Example 1 was changed to 45%, and evaluations were performed under the same conditions as in Example 1. The results are presented in Table 3 below.

### Example 8

A thermosensitive recording medium produced under the same conditions as in Example 7 was subjected to recording under the same conditions as in Example 1, except that the laser power in <Recording on thermosensitive recording medium> of Example 1 was changed to 60%, and evaluations were performed under the same conditions as in Example 1. The results are presented in Table 3 below.

### Example 9

A thermosensitive recording medium produced under the same conditions as in Example 7 was subjected to recording under the same conditions as in Example 1, except that the laser power in <Recording on thermosensitive recording medium> of Example 1 was changed to 70%, and evaluations were performed under the same conditions as in Example 1. The results are presented in Table 3 below.

### Example 10

A thermosensitive recording medium was produced under the same conditions as in Example 1, except that in <Production of thermosensitive coating material (C Liquid)> of Example 1, the amount of the A Liquid was changed to 24.4 parts by mass. The thermosensitive recording medium was subjected to recording under the same conditions as in Example 1 except that the laser power in <Recording on thermosensitive recording medium> of Example 1 was changed to 60%, and evaluations were performed under the same conditions as in Example 1. The results are presented in Table 3 below.

### Example 11

A thermosensitive recording medium produced under the same conditions as in Example 10 was subjected to recording under the same conditions as in Example 1, except that the laser power in <Recording on thermosensitive recording medium> of Example 1 was changed to 75%, and evaluations were performed under the same conditions as in Example 1. The results are presented in Table 3 below.

### Example 12

A thermosensitive recording medium produced under the same conditions as in Example 10 was subjected to recording under the same conditions as in Example 1, except that the laser power in <Recording on thermosensitive recording medium> of Example 1 was changed to 90%, and evaluations were performed under the same conditions as in Example 1. The results are presented in Table 3 below.

### Example 13

A thermosensitive recording medium was produced under the same conditions as in Example 4, except that in <Production of thermosensitive coating material (E Liquid)> of Example 4, the added amount of the styrene-acrylic resin emulsion (Joncryl PDX7323, available from BASF SE, glass transition temperature: 30 degrees Celsius, solid content: 42% by mass) was changed to 17.4 parts by mass. The thermosensitive recording medium was subjected to recording under the same conditions as in Example 1 except that the laser power in <Recording on thermosensitive recording medium> of Example 1 was changed to 45%, and evaluations were performed under the same conditions as in Example 1. The results are presented in Table 3 below.

### Example 14

A thermosensitive recording medium was produced under the same conditions as in Example 4, except that in <Production of thermosensitive coating material (E Liquid)> of Example 4, the added amount of the D Liquid was changed to 24.4 parts by mass. The thermosensitive recording medium was subjected to recording under the same conditions as in Example 1 except that the laser power in <Recording on thermosensitive recording medium> of Example 1 was changed to 60%, and evaluations were performed under the same conditions as in Example 1. The results are presented in Table 3 below.

### Example 15

A thermosensitive recording medium was produced under the same conditions as in Example 4, except that in <Production of thermosensitive recording medium> of Example 4, a biaxially oriented polypropylene (OPP: Suntox-OP PA30 corona treated) film having a thickness of 30 micrometers and a haze value of 3.0 was used instead of the polyethylene terephthalate (PET) film having a thickness of 50 micrometers. The thermosensitive recording medium was subjected to recording under the same conditions as in Example 1 and evaluations were performed under the same conditions as in Example 1. The results are presented in Table 3 below.

### Example 16

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².

Organic resin layer composition: a polyacrylonitrile resin (BARIASTAR 1000, available from Mitsui Chemicals, Inc.)

Thereafter, the (E Liquid) was applied onto the organic resin layer by a wire bar, the applied (E Liquid) was dried to dispose a thermosensitive recording layer having a deposition amount of 8.8 g/m², to thereby obtain a thermosensitive recording medium.

The thermosensitive recording medium was subjected to recording under the same conditions as in Example 1 and evaluations were performed under the same conditions as in Example 1. The results are presented in Table 3 below.

### Example 17

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².

Organic resin layer composition: a urethane resin (Neo Rez R-600, available from DSM Neo Resins)

Thereafter, the (E Liquid) was applied onto the organic resin layer by a wire bar, the applied (E Liquid) was dried to dispose a thermosensitive recording layer having a deposition amount of 8.8 g/m², to thereby obtain a thermosensitive recording medium.

The thermosensitive recording medium was subjected to recording under the same conditions as in Example 1 and evaluations were performed under the same conditions as in Example 1. The results are presented in Table 3 below.

### Example 18

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².
Organic resin layer composition: a urethane resin (HYDRAN WLS-210, available from DIC Corporation)
Thereafter, the (E Liquid) was applied onto the organic resin layer by a wire bar, the applied (E Liquid) was dried to dispose a thermosensitive recording layer having a deposition amount of 8.8 g/m², to thereby obtain a thermosensitive recording medium. The thermosensitive recording medium was subjected to recording under the same conditions as in Example 1 except that the laser power in <Recording on thermosensitive recording medium> of Example 1 was changed to 60%, and evaluations were performed under the same conditions as in Example 1. The results are presented in Table 3 below.

### Example 19

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².

Adhesion layer composition: urethane resin (Neo Rez R-600, available from DSM Neo Resins)

Thereafter, the (E Liquid) was applied onto the organic resin layer by a wire bar, and the applied (E Liquid) was dried to dispose a thermosensitive recording layer having a deposition amount of 8.8 g/m².

Next, the following organic resin layer composition was applied onto a surface of the thermosensitive recording layer in a manner that a film thickness of the organic resin layer composition after drying was to be 7.1 g/m², and the applied organic resin layer composition was dried, to thereby obtain a thermosensitive recording medium.

Organic resin layer composition: a polyacrylonitrile resin (BARIASTAR 1000, available from Mitsui Chemicals, Inc.)

The thermosensitive recording medium was subjected to recording under the same conditions as in Example 1 and evaluations were performed under the same conditions as in Example 1. The results are presented in Table 3 below.

### Example 20

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².

Organic resin layer composition: a urethane resin (Neo Rez R-600, available from DSM Neo Resins)
Thereafter, the (E Liquid) was applied onto the organic resin layer by a wire bar, and the applied (E Liquid) was dried to dispose a thermosensitive recording layer having a deposition amount of 8.8 g/m².
Next, the following organic resin layer composition was applied onto a surface of the thermosensitive recording layer in a manner that a film thickness of the organic resin layer composition after drying was to be 7.1 g/m², and the applied organic resin layer composition was dried, to thereby obtain a thermosensitive recording medium.
Organic resin layer composition: an acrylic polyol resin (LR-503 available from MITSUBISHI RAYON CO., LTD., crosslinking agent (CORONATE HL, available from Nippon Polyurethane Industry Co., Ltd.))
The thermosensitive recording medium was subjected to recording under the same conditions as in Example 19 and evaluations were performed under the same conditions as in Example 1. The results are presented in Table 3 below.

### Example 21

The following resin was applied as an organic resin layer onto a biaxially oriented polypropylene (OPP: Suntox-OP PA30 corona treated) film having a thickness of 30 micrometers in a manner that a film thickness of the resin after drying was to be 1.2 g/m².

Organic resin layer composition: an acrylic polyol resin (LR-503 available from MITSUBISHI RAYON CO., LTD., crosslinking agent (CORONATE HL, available from Nippon Polyurethane Industry Co., Ltd.))

Thereafter, the (E Liquid) was applied onto the organic resin layer by a wire bar, and the applied (E Liquid) was dried to dispose a thermosensitive recording layer having a deposition amount of 8.8 g/m².

Next, the following organic resin layer composition was applied onto the thermosensitive recording layer in a manner that a film thickness of the organic resin layer composition after drying was to be 7.1 g/m², and the applied organic resin layer composition was dried, to thereby obtain a thermosensitive recording medium.

Adhesion layer composition: a urethane resin (Neo Rez R-600, available from DSM Neo Resins)

The thermosensitive recording medium was subjected to recording under the same conditions as in Example 19 and evaluations were performed under the same conditions as in Example 1. The results are presented in Table 3 below.

### Example 22

The following organic resin layer composition was applied onto surfaces of the organic resin layer and recording layer produced in Example 19 in a manner that a film thickness of each organic resin layer after drying was to be 2 g/m², and the applied organic resin layer composition was cured for 16 hours at 40 degrees Celsius.

Adhesion layer composition: a urethane resin (Neo Rez R-600, available from DSM Neo Resins)
Meanwhile, a dry laminate resin having the following composition was applied onto a biaxially oriented polypropylene (OPP: Suntox-OP PA20 corona treated) film having a thickness of 20 micrometers in a manner that a film thickness of the dry laminate resin after drying was to be 7 g/m². A surface of the dry laminate resin layer and a surface of the recording layer were met to laminate at nip pressure of 150 g/cm, and line speed of 2 m/min, and the dry laminate resin was crosslinked for 16 hours at 40 degrees Celsius. Dry laminate resin: (E372, available from Dainichiseika Color & Chemicals Mfg. Co., Ltd., crosslinking agent (C76, available from Dainichiseika Color & Chemicals Mfg. Co., Ltd.))
The thermosensitive recording medium was subjected to recording under the same conditions as in Example 19 and evaluations were performed under the same conditions as in Example 1. The results are presented in Table 3 below.

### Comparative Example 1

A thermosensitive recording medium was produced under the same conditions as in Example 1, except that in the composition and the thermosensitive recording medium, a thermosensitive recording composition free from aluminium hydroxide was applied in a manner that a film thickness after drying was to be identical to the film thickness in Example 1.

The thermosensitive recording medium was subjected to recording under the same conditions as in Example 1 and evaluations were performed under the same conditions as in Example 1. The results are presented in Table 4 below. An enlarged photograph with a magnification of 650 times, depicting a surface of the thermosensitive recording medium after information recording is presented in FIG. 3B.

### Comparative Example 2

A thermosensitive recording medium was produced under the same conditions as in Example 1, except that in the composition and the thermosensitive recording medium of Example 1, the thermoplastic resin was changed to the following ethylene-vinyl acetate copolymer resin having glass transition temperature of 0 degrees Celsius.

<Production of Thermosensitive Coating Material (F Liquid)>

The following composition was stirred and mixed to thereby obtain a thermosensitive coating material (F Liquid).

The (A Liquid): 48.8 parts by mass

Ethylene-vinyl acetate copolymer resin emulsion (an ethylene-vinyl acetate copolymer, SUMIKAFLEX 400HQ, available from Sumitomo Chemical Co., Ltd., glass transition temperature: 0 degrees Celsius, solid content: 55% by mass): 26.6 parts by mass

The (B Liquid): 7.7 parts by mass
Water: 16.9 parts by mass
The thermosensitive recording medium was subjected to recording under the same conditions as in Example 1 and evaluations were performed under the same conditions as in Example 1. The results are presented in Table 4 below.

### Example 23

A thermosensitive recording medium was produced under the same conditions as in Example 1, except that in the composition and the thermosensitive recording medium of Example 1, the thermoplastic resin was changed to the following styrene-acrylic resin emulsion (styrene-acryl copolymer) having glass transition temperature of 113 degrees Celsius.

<Production of Thermosensitive Coating Material (G Liquid)>

The following composition was stirred and mixed to thereby obtain a thermosensitive coating material (G Liquid).

The (A Liquid): 48.8 parts by mass

Styrene-acrylic resin emulsion (a styrene-acryl copolymer, Joncryl PDX7177, available from available from BASF SE, glass transition temperature: 113 degrees Celsius, solid content: 42% by mass): 34.8 parts by mass

The (B Liquid): 7.7 parts by mass

Water: 16.9 parts by mass

The thermosensitive recording medium was subjected to recording under the same conditions as in Example 1 and evaluations were performed under the same conditions as in Example 1. The results are presented in Table 3 below.

### Example 24

A thermosensitive recording medium was produced under the same conditions as in Example 1, except that in the composition and the thermosensitive recording medium of Example 1, the thermoplastic resin was changed to the following styrene-acrylic resin emulsion (styrene-acryl copolymer) having glass transition temperature of 75 degrees Celsius.

<Production of Thermosensitive Coating Material (H Liquid)>

The following composition was stirred and mixed to thereby obtain a thermosensitive coating material (H Liquid).

The (A Liquid): 48.8 parts by mass

Styrene-acrylic resin emulsion (a styrene-acryl copolymer, Joncryl PDX7667, available from available from BASF SE, glass transition temperature: 75 degrees Celsius, a liquid having a solid content of 45% by mass was diluted to have a solid content of 42% by mass): 34.8 parts by mass

The (B Liquid): 7.7 parts by mass
Water: 8.7 parts by mass
The thermosensitive recording medium was subjected to recording under the same conditions as in Example 1 and evaluations were performed under the same conditions as in Example 1. The results are presented in Table 3 below.

### Example 25

A thermosensitive recording medium was produced under the same conditions as in Example 1, except that in the composition and the thermosensitive recording medium of Example 1, the thermoplastic resin was changed to the following styrene-acrylic resin emulsion (styrene-acryl copolymer) having glass transition temperature of 15 degrees Celsius.

<Production of Thermosensitive Coating Material (I Liquid)>

The following composition was stirred and mixed to thereby obtain a thermosensitive coating material (I Liquid).

The (A Liquid): 48.8 parts by mass

Styrene-acrylic resin emulsion (a styrene-acryl copolymer, Joncryl PDX7341, available from available from BASF SE, glass transition temperature: 15 degrees Celsius, a liquid having a solid content of 49% by mass was diluted to have a solid content of 42% by mass): 34.8 parts by mass

The (B Liquid): 7.7 parts by mass

Water: 8.7 parts by mass

The thermosensitive recording medium was subjected to recording under the same conditions as in Example 1 and evaluations were performed under the same conditions as in Example 1. The results are presented in Table 3 below.

### Comparative Example 3

A thermosensitive recording medium produced under the same conditions as in Example 1 was subjected to recording under the same conditions as in Example 1, except that the laser power in <Recording on thermosensitive recording medium> of Example 1 was changed to 35%, and evaluations were performed under the same conditions as in Example 1. The results are presented in Table 4 below.

### Comparative Example 4

A thermosensitive recording medium produced under the same conditions as in Example 1 was subjected to recording under the same conditions as in Example 1, except that the laser power in <Recording on thermosensitive recording medium> of Example 1 was changed to 95%, and evaluations were performed under the same conditions as in Example 1. The results are presented in Table 4 below.

### Comparative Example 5

A thermosensitive recording medium was produced under the same conditions as in Example 1, except that in <Production of thermosensitive coating material (C Liquid)> of Example 1, the added amount of the styrene-acrylic resin emulsion (Joncryl PDX7323, available from BASF SE, glass transition temperature: 30 degrees Celsius, solid content: 42% by mass) was changed to 10.0 parts by mass. The thermosensitive recoding medium was subjected to recording under the same conditions as in Example 1, and evaluations were performed under the same conditions as in Example 1. The results are presented in Table 4 below.

### Comparative Example 6

A thermosensitive recording medium produced under the same conditions as in Comparative Example 5 was subjected to recording under the same conditions as in Example 1, except that the laser power in <Recording on thermosensitive recording medium> of Example 1 was changed to 35%, and evaluations were performed under the same conditions as in Example 1. The results are presented in Table 4 below.

### Comparative Example 7

A thermosensitive recording medium was produced under the same conditions as in Example 1, except that in <Production of thermosensitive coating material (C Liquid)> of Example 1, the added amount of the A Liquid was changed to 16.3 parts by mass. The thermosensitive recoding medium was subjected to recording under the same conditions as in Example 1, and evaluations were performed under the same conditions as in Example 1. The results are presented in Table 4 below.

### Comparative Example 8

A thermosensitive recording medium produced under the same conditions as in Comparative Example 7 was subjected to recording under the same conditions as in Example 1, except that the laser power in <Recording on thermosensitive recording medium> of Example 1 was changed to 65%, and evaluations were performed under the same conditions as in Example 1. The results are presented in Table 4 below.

Structures and information recording conditions of the thermosensitive recording media of Examples and Comparative Examples are presented in Tables 1 and 2 below.

TABLE 1

| | | | Organic | Recording layer | | | | | | | |
|---|---|---|---|---|---|---|---|---|---|---|---|
| | | | resin layer | (A | (D | | | | | | |
| | | | between | Liquid) | Liquid) | | Thermoplastic resin | | | | |
| | | | base and | Amount | Amount | | | | Amount | | Laser |
| | | | recording | (mass | (mass | Fine | | Tg | (mass | Laminate | power |
| | | Base | layer | parts) | parts) | particles | Type | (° C.) | parts) | base | (%) |
| Ex- | 1 | PET | Absent | 48.8 | — | aluminium | styrene-acryl | 30 | 34.8 | — | 50 |
| ample | | | | | | hydroxide | copolymer | | | | |
| | 2 | PET | Absent | 48.8 | — | aluminium | styrene-acryl | 30 | 34.8 | — | 65 |
| | | | | | | hydroxide | copolymer | | | | |
| | 3 | PET | Absent | 48.8 | — | aluminium | styrene-acryl | 30 | 34.8 | — | 80 |
| | | | | | | hydroxide | copolymer | | | | |
| | 4 | PET | Absent | — | 48.8 | calcium | styrene-acryl | 30 | 34.8 | — | 50 |
| | | | | | | carbonate | copolymer | | | | |
| | 5 | PET | Absent | — | 48.8 | calcium | styrene-acryl | 30 | 34.8 | — | 65 |
| | | | | | | carbonate | copolymer | | | | |
| | 6 | PET | Absent | — | 48.8 | calcium | styrene-acryl | 30 | 34.8 | — | 80 |
| | | | | | | carbonate | copolymer | | | | |
| | 7 | PET | Absent | 48.8 | — | aluminium | styrene-acryl | 30 | 17.4 | — | 45 |
| | | | | | | hydroxide | copolymer | | | | |
| | 8 | PET | Absent | 48.8 | — | aluminium | styrene-acryl | 30 | 17.4 | — | 60 |
| | | | | | | hydroxide | copolymer | | | | |
| | 9 | PET | Absent | 48.8 | — | aluminium | styrene-acryl | 30 | 17.4 | — | 70 |
| | | | | | | hydroxide | copolymer | | | | |
| | 10 | PET | Absent | 24.4 | — | aluminium | styrene-acryl | 30 | 34.8 | — | 60 |
| | | | | | | hydroxide | copolymer | | | | |
| | 11 | PET | Absent | 24.4 | — | aluminium | styrene-acryl | 30 | 34.8 | — | 75 |
| | | | | | | hydroxide | copolymer | | | | |
| | 12 | PET | Absent | 24.4 | — | aluminium | styrene-acryl | 30 | 34.8 | — | 90 |
| | | | | | | hydroxide | copolymer | | | | |
| | 13 | PET | Absent | — | 48.8 | calcium | styrene-acryl | 30 | 17.4 | — | 45 |
| | | | | | | carbonate | copolymer | | | | |
| | 14 | PET | Absent | — | 24.4 | calcium | styrene-acryl | 30 | 34.8 | — | 60 |
| | | | | | | carbonate | copolymer | | | | |
| | 15 | OPP | Absent | — | 48.8 | calcium | styrene-acryl | 30 | 34.8 | — | 50 |
| | | | | | | carbonate | copolymer | | | | |
| | 16 | OPP | Present | — | 48.8 | calcium | styrene-acryl | 30 | 34.8 | — | 50 |
| | | | | | | carbonate | copolymer | | | | |
| | 17 | OPP | Present | — | 48.8 | calcium | styrene-acryl | 30 | 34.8 | — | 50 |
| | | | | | | carbonate | copolymer | | | | |
| | 18 | OPP | Present | — | 48.8 | calcium | styrene-acryl | 30 | 34.8 | — | 50 |
| | | | | | | carbonate | copolymer | | | | |
| | 19 | OPP | Present | — | 48.8 | calcium | styrene-acryl | 30 | 34.8 | — | 60 |
| | | | | | | carbonate | copolymer | | | | |
| | 20 | OPP | Present | — | 48.8 | calcium | styrene-acryl | 30 | 34.8 | — | 60 |
| | | | | | | carbonate | copolymer | | | | |
| | 21 | OPP | Present | — | 48.8 | calcium | styrene-acryl | 30 | 34.8 | — | 60 |
| | | | | | | carbonate | copolymer | | | | |
| | 22 | OPP | Present | — | — | calcium | styrene-acryl | 30 | 34.8 | OPP | 60 |
| | | | | | | carbonate | copolymer | | | | |
| | 23 | PET | — | 48.8 | — | aluminium | styrene-acryl | 113 | 34.8 | — | 50 |
| | | | | | | hydroxide | copolymer | | | | |
| | 24 | PET | — | 48.8 | — | aluminium | styrene-acryl | 75 | 34.8 | — | 50 |
| | | | | | | hydroxide | copolymer | | | | |
| | 25 | PET | — | 48.8 | — | aluminium | styrene-acryl | 15 | 34.8 | — | 50 |
| | | | | | | hydroxide | copolymer | | | | |

TABLE 2

| | | | Organic | Recording layer | | | | | | | |
|---|---|---|---|---|---|---|---|---|---|---|---|
| | | | resin layer | (A | (D | | | | | | |
| | | | between | Liquid) | Liquid) | | Thermoplastic resin | | | | |
| | | | base and | Amount | Amount | | | | Amount | | Laser |
| | | | recording | (mass | (mass | Fine | | Tg | (mass | Laminate | power |
| | | Base | layer | parts) | parts) | particles | Type | (° C.) | parts) | base | (%) |
| Comp. | 1 | PET | — | — | — | — | styrene-acryl | 30 | 34.8 | — | 50 |
| Ex. | | | | | | | copolymer | | | | |
| | 2 | PET | — | 48.8 | — | aluminium | ethylene-vinyl | 0 | 26.6 | — | 50 |
| | | | | | | hydroxide | acetate | | | | |
| | | | | | | | copolymer | | | | |
| | 3 | PET | — | 48.8 | — | aluminium | styrene-acryl | 30 | 34.8 | — | 35 |
| | | | | | | hydroxide | copolymer | | | | |
| | 4 | PET | — | 48.8 | — | aluminium | styrene-acryl | 30 | 34.8 | — | 95 |
| | | | | | | hydroxide | copolymer | | | | |
| | 5 | PET | — | 48.8 | — | aluminium | styrene-acryl | 30 | 10 | — | 50 |
| | | | | | | hydroxide | copolymer | | | | |
| | 6 | PET | — | 48.8 | — | aluminium | styrene-acryl | 30 | 10 | — | 35 |
| | | | | | | hydroxide | copolymer | | | | |
| | 7 | PET | — | 16.3 | — | aluminium | styrene-acryl | 30 | 34.8 | — | 50 |
| | | | | | | hydroxide | copolymer | | | | |
| | 8 | PET | — | 16.3 | — | aluminium | styrene-acryl | 30 | 34.8 | — | 65 |
| | | | | | | hydroxide | copolymer | | | | |

TABLE 3

| | | Evaluation results | | | | | | | | |
|---|---|---|---|---|---|---|---|---|---|---|
| | | | | | | Film | Pore | Pore diameter | | |
| | | | | | | thickness after | diameter of | relative to film | | |
| | | | | | | information | bubbles | thickness of | | |
| | | | | Film thickness | | recording | along | area irradiated | Defective | |
| | | | Conceal- | before | after | relative to film | thickness | with laser | image | Physical |
| | | Color | ment | information | information | thickness before | direction of | light after | Floating | durability |
| | | difference | Image | recording | recording | information | recording | information | of solid | of |
| | | Delta E | density | (μm) | (μm) | recording (%) | layer (μm) | recording (%) | area | image |
| Ex- | 1 | 7.5 | 0.41 | 5.9 | 8.9 | 151 | 1.3 | 15.0 | Absent | 4 |
| ample | 2 | 7.5 | 0.39 | 5.9 | 11.5 | 195 | 2.9 | 25.0 | Absent | 3 |
| | 3 | 7.5 | 0.38 | 5.9 | 14.7 | 249 | 5.1 | 35.0 | Absent | 3 |
| | 4 | 5.5 | 0.36 | 5.9 | 9 | 153 | 1.2 | 13.0 | Absent | 4 |
| | 5 | 5.5 | 0.36 | 5.9 | 11.7 | 198 | 2.1 | 18.0 | Absent | 4 |
| | 6 | 5.5 | 0.36 | 5.9 | 14.5 | 246 | 4.4 | 30.0 | Absent | 4 |
| | 7 | 18.6 | 0.41 | 5.9 | 9 | 153 | 1.8 | 20.0 | Absent | 4 |
| | 8 | 18.6 | 0.37 | 5.9 | 12 | 203 | 3.2 | 27.0 | Absent | 3 |
| | 9 | 18.6 | 0.34 | 5.9 | 14.5 | 246 | 6.4 | 44.0 | Absent | 3 |
| | 10 | 4.3 | 0.41 | 5.9 | 8.7 | 147 | 1.5 | 17.0 | Absent | 4 |
| | 11 | 4.3 | 0.37 | 5.9 | 11.7 | 198 | 2.8 | 24.0 | Absent | 3 |
| | 12 | 4.3 | 0.35 | 6 | 13.6 | 227 | 6.8 | 50.0 | Absent | 3 |
| | 13 | 16.1 | 0.36 | 5.9 | 9 | 153 | 1.7 | 19.0 | Absent | 4 |
| | 14 | 6.3 | 0.36 | 5.9 | 8.8 | 149 | 1.6 | 18.0 | Absent | 4 |
| | 15 | 7.0 | 0.36 | 5.9 | 10 | 169 | 1.1 | 11.0 | Partially | 3 |
| | | | | | | | | | slight | |
| | | | | | | | | | floating | |
| | 16 | 7.5 | 0.38 | 5.9 | 8.9 | 151 | 0.9 | 10.0 | Absent | 4 |
| | 17 | 7.3 | 0.38 | 5.9 | 8.8 | 149 | 1.0 | 11.0 | Absent | 4 |
| | 18 | 7.7 | 0.38 | 5.9 | 9 | 153 | 0.9 | 10.0 | Absent | 4 |
| | 19 | 8.2 | 0.38 | 5.9 | 8.9 | 151 | 1.0 | 11.0 | Absent | 5 |
| | 20 | 8.0 | 0.38 | 5.9 | 9.1 | 154 | 1.0 | 11.0 | Absent | 5 |
| | 21 | 10.2 | 0.38 | 5.9 | 9 | 153 | 1.0 | 11.0 | Absent | 5 |
| | 22 | 8.5 | 0.37 | 5.9 | 9.2 | 156 | 1.1 | 12.0 | Absent | 5 |
| | 23 | 8.0 | 0.40 | 5.9 | 9.9 | 168 | 1.8 | 18.0 | Absent | 3 |
| | 24 | 7.5 | 0.40 | 5.9 | 9.7 | 164 | 1.6 | 16.0 | Absent | 4 |
| | 25 | 7.7 | 0.50 | 5.9 | 8.3 | 141 | 1.0 | 12.0 | Absent | 4 |

TABLE 4

| | | Evaluation results | | | | | | | | |
|---|---|---|---|---|---|---|---|---|---|---|
| | | | | | | Film | Pore | Pore diameter | | |
| | | | | | | thickness after | diameter of | relative to film | | |
| | | | | | | information | bubbles | thickness of | | |
| | | | | Film thickness | | recording | along | area irradiated | Defective | |
| | | | Conceal- | before | after | relative to film | thickness | with laser | image | Physical |
| | | Color | ment | information | information | thickness before | direction of | light after | Floating | durability |
| | | difference | Image | recording | recording | information | recording | information | of solid | of |
| | | Delta E | density | (μm) | (μm) | recording (%) | layer (μm) | recording (%) | area | image |
| Comp. | 1 | 1.4 | 1.05 | 5.9 | 6.1 | 103 | 5.5 | 90.0 | Absent | 5 |
| Ex- | 2 | 9.5 | 0.84 | 5.9 | 7.3 | 128 | 0.7 | 9.0 | Absent | 5 |
| ample | 3 | 7.5 | 1.03 | 5.9 | 7 | 119 | 0.5 | 7.0 | Absent | 5 |
| | 4 | 7.5 | 0.51 | 5.9 | 16 | 271 | 3.7 | 23.0 | Present | 2 |
| | 5 | 23.5 | 0.36 | 5.9 | 12 | 203 | 2.9 | 24.0 | Present | 1 |
| | 6 | 23.5 | 0.39 | 5.9 | 8.9 | 151 | 1.4 | 16.0 | Present | 1 |
| | 7 | 4.5 | 0.56 | 5.9 | 7 | 119 | 2.1 | 30.0 | Absent | 5 |
| | 8 | 4.5 | 0.52 | 5.7 | 7.9 | 139 | 3.7 | 47.0 | Absent | 5 |

Aspects of the present disclosure are as follows.

<1> A thermosensitive recording medium including:

a base; and

a recording layer including a photothermal conversion material and disposed on the base,

wherein the thermosensitive recording medium is configured to record information in the thermosensitive recording medium through laser light irradiation, and

wherein a color difference delta E between a color tone A of a background observed through the thermosensitive recording medium in which information is not recorded and a color tone B of the background directly observed without the thermosensitive recording medium in which information is not recorded is 20 or less, and

a film thickness D of an area of the recording layer irradiated with laser light after information recording performed by laser light irradiation is 140% or greater but 250% or less relative to a film thickness C of the recording layer of the thermosensitive recording medium in which information is not recorded.

<2> The thermosensitive recording medium according to <1>,

wherein a pore diameter of bubbles along a thickness direction of the recording layer, where the bubbles are generated in the area of the recording layer irradiated with laser light after information recording, is 10% or greater but 30% or less relative to the film thickness of the area of the recording layer irradiated with laser light after information recording.

<3> The thermosensitive recording medium according to <1> or <2>,

wherein the recording layer further includes fine particles and a thermoplastic resin having glass transition temperature of 20 degrees Celsius or higher but 80 degrees Celsius or lower,

the fine particles and the thermoplastic resin are present in a closely-packed state, and the photothermal conversion material is homogeneously dispersed in the thermoplastic resin.

<4> The thermosensitive recording medium according to <3>,

wherein a mass ratio (A:B) between the fine particles A and the thermoplastic resin B is from 1:5 through 1:0.1.

<5> The thermosensitive recording medium according to <3> or <4>,

wherein the fine particles includes at least one selected from the group consisting of a metal oxide, a metal hydroxide, a hydrate of metal oxide, a basic metal chloride, a hydrate of a metal salt, a clay mineral, a carbonic acid salt, a basic carbonic acid salt, and a hydrogen carbonate.

<6> The thermosensitive recording medium according to <5>,

wherein the metal hydroxide includes at least one selected from the group consisting of aluminium hydroxide, magnesium hydroxide, and calcium hydroxide.

<7> The thermosensitive recording medium according to <6>,

wherein the metal hydroxide includes aluminium hydroxide.

<8> The thermosensitive recording medium according to any one of <5> to <7>,

wherein the carbonic acid salt includes at least one selected from the group consisting of zinc carbonate, calcium carbonate, and magnesium carbonate.

<9> The thermosensitive recording medium according to <8>,

wherein the carbonic acid salt includes calcium carbonate.

<10> The thermosensitive recording medium according to any one of <3> to <9>,

wherein an amount of the fine particles is 20% by mass or greater but 90% by mass or less relative to a total amount of the recording layer.

<11> The thermosensitive recording medium according to any one of <3> to <10>,

wherein the thermoplastic resin having glass transition temperature of 20 degrees Celsius or higher but 80 degrees Celsius or lower includes an organic binder.

<12> The thermosensitive recording medium according to <11>,

wherein the organic binder includes at least one of an acrylic resin and a styrene-acryl copolymer.

<13> The thermosensitive recording medium according to any one of <1> to <12>,

wherein the photothermal conversion material includes at least one of an inorganic-based material and an organic-based material.

<14> The thermosensitive recording medium according to <13>,

wherein the inorganic-based material includes metal oxide.

<15> The thermosensitive recording medium according to <14>,

wherein the metal oxide includes a tungsten oxide compound.

<16> The thermosensitive recording medium according to <15>,

wherein the tungsten oxide compound includes cesium-containing tungsten oxide.

<17> The thermosensitive recording medium according to any one of <1> to <16>,

wherein a material of the base includes at least one of an inorganic material and an organic material.

<18> The thermosensitive recording medium according to <17>,

wherein the organic material includes at least one of polyethylene terephthalate and polypropylene.

<19> The thermosensitive recording medium according to any one of <1> to <18>, further including an organic resin layer, which is a single layer or a multiple layer and is disposed between the base and the recording layer, or on a surface of the recording layer, or between the base and the recording layer and on the surface of the recording layer.

<20> The thermosensitive recording medium according to <19>, further including a film on the organic resin layer disposed on the surface of the recording layer.

The thermosensitive recording medium according to any one of <1> to <20> can solve the various problems existing in the art, and can achieve the object of the present disclosure.

1-5. (canceled)

6. A thermosensitive recording medium comprising:
a base; and
a recording layer including a photothermal conversion material configured to absorb semiconductor laser light and convert the absorbed light into heat, a resin, and fine particles, where the recording layer is disposed on the base,
wherein a color difference delta E, which is represented by Formula 1 below, between a color tone A of a background observed through the thermosensitive recording medium and a color tone B of the background directly observed without the thermosensitive recording medium is 20 or less, and
a film thickness D of an area of the recording layer irradiated with laser light is 140% or greater but 250% or less relative to a film thickness C of the recording layer,
Delta E=((L*₁−L*₀)²+(a*₁−a*₀)²+(b*₁−b*₀)²))^{0.5} Formula 1
where, in Formula 1, L*₁, a*₁, and b*₁ are L*a*b* values of the color tone A of the background observed through the thermosensitive recording medium, and L*₀, a*₀, and b*₀ are L*a*b* values of the color tone B of the background directly observed without the thermosensitive recording medium.

7. The thermosensitive recording medium according to claim 6,
wherein a pore diameter of bubbles along a thickness direction of the recording layer, where the bubbles are generated in the area of the recording layer irradiated with laser light, is 10% or greater but 30% or less relative to the film thickness D of the area of the recording layer irradiated with laser light.

8. The thermosensitive recording medium according to claim 6,
wherein the resin is a thermoplastic resin and glass transition temperature of the thermoplastic resin is 20 degrees Celsius or higher but 80 degrees Celsius or lower.

9. The thermosensitive recording medium according to claim 6, further comprising an organic resin layer, which is a single layer or a multiple layer and is disposed between the base and the recording layer, or on a surface of the recording layer, or between the base and the recording layer and on the surface of the recording layer.

10. The thermosensitive recording medium according to claim 9, further comprising a film on the organic resin layer disposed on the surface of the recording layer.

11. The thermosensitive recording medium according to claim 6,
wherein the area of the recording layer irradiated with laser light has light transmittance lower than light transmittance of the area of the recording layer before being irradiated with laser light.

12. The thermosensitive recording medium according to claim 6,
wherein the recording layer is in a transparent state, and the area of the recording layer irradiated with laser light is turned into a white-colored state.

13. The thermosensitive recording medium according to claim 6,
wherein a mass ratio (fine particles:resin) between the fine particles and the resin is from 1:2 through 1:0.3.

14. The thermosensitive recording medium according to claim 6,
wherein the fine particles include at least one selected from the group consisting of a metal oxide, a metal hydroxide, a hydrate of metal oxide, a basic metal chloride, a hydrate of a metal salt, a clay mineral, a carbonic acid salt, a basic carbonic acid salt, and a hydrogen carbonate.

15. The thermosensitive recording medium according to claim 6,
wherein an amount of the fine particles is 20% by mass or greater but 90% by mass or less relative to a total amount of the recording layer.

16. The thermosensitive recording medium according to claim 6,
wherein a volume average particle diameter of the fine particles is 0.07 micrometers or greater but 0.5 micrometers or less.

17. The thermosensitive recording medium according to claim 6,
wherein the resin includes at least one of an acrylic resin and a styrene-acryl copolymer.

18. The thermosensitive recording medium according to claim 6,
wherein the photothermal conversion material is an inorganic-based material.

19. The thermosensitive recording medium according to claim 6,
wherein the photothermal conversion material is a metal oxide.

20. The thermosensitive recording medium according to claim 6,
wherein the photothermal conversion material is a tungsten oxide compound.

21. The thermosensitive recording medium according to claim 6,
wherein the photothermal conversion material is cesium-containing tungsten oxide.

22. A thermosensitive recording method comprising:
irradiating the thermosensitive recording medium according to claim 6 with semiconductor laser light to perform recording on the thermosensitive recording medium.
